(19) United States
(12) Patent Application Publication
(10) Pub. No.: US 2011/0017303 A1
(43) Pub. Date: Jan. 27, 2011

(54) TIME FLOW VALVE

(75) Inventor: Elias Hajjar, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Microflow International Pty Limited, Darlinghurst (AU)

(21) Appl. No.: 12/811,659

(22) PCT Filed: Dec. 24, 2008
(86) PCT No.: PCT/AU2008/001921

§ 371 Date: Oct. 11, 2010

(30) Foreign Application Priority Data
Jan. 2, 2008 (AU) 200890020

(51) Int. Cl. F15D 1/00; F16K 31/02

(52) U.S. Cl. 137/1; 251/129.02; 137/544; 137/624.11; 137/343

(57) ABSTRACT

A fluid valve which opens for a predetermined time before automatically closing. The valve (101) incorporates a control means including a control chamber (103), a first/inlet passageway (102) and a second/outlet passageway (120). A flow control element (104) is provided in one of the passageways (102) or (120). A biasing means (117) normally biases the valve to a first/closed position (FIG. 3). An activation means (113) is adapted to move the flow control element (104) to an activated position (FIG. 4) wherein flow of fluid is then permitted for a predetermined time.

### BACKGROUND OF THE INVENTION

The present invention relates to a fluid valve, and in particular to a fluid valve which, when activated, opens for a predetermined period of time before automatically closing. The present invention also provides a valve which, in a preferred embodiment, provides an additional function to be able to manually turn it off any time before shutting automatically.

The valve of the present invention is a pressure balanced pilot operated valve incorporating an automatically movable flow control element arrangement.

### DESCRIPTION OF THE PRIOR ART

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

Conventional valves typically have a valve seat and a movable valve member. The movable valve member bears against the valve seat to control the fluid flow. An actuator acts directly on the valve member to cause movement of the valve member. In such conventional valves, the forces required to move the valve may be quite large.

The Applicant has herebefore designed an improvement to these conventional valves which substantially overcomes the drawbacks of the prior art by providing a valve which is capable of being operated using substantially lower forces than required in the conventional type valves. Details of the Applicant's prior art valve device are described in the Applicant's earlier patents/applications, including International Application No. PCT/AU1996/00263, the disclosures of which should be considered to be entirely incorporated herein by this reference thereto.

In the Applicant's earlier patent application, there is defined a valve device which includes a control chamber, passageways communicating the control chamber with inlet and outlet ports, and a flow control element within at least one of the passageways. The flow control element effectively controls the flow of fluid within the passageways to thereby control the flow of fluid between the inlet and outlet of the valve device, per se.

### SUMMARY OF THE INVENTION

The present invention seeks to provide a valve device which, when activated, opens for a period of time before automatically closing.

The present invention seeks to provide such a time flow valve device which may be activated using considerably less forces than in conventional valves.

In one broad form, the present invention provides a valve device, including:

a fluid inlet;

a fluid outlet;

a valve seat, defining an opening through which fluid is adapted to flow from said inlet to said outlet;

a valve member, movable relative to said valve seat between an open and a closed position;

a control means, to operate said valve device for a predetermined period of time, said control means including:
a control chamber;
a first fluid passageway between said inlet and said control chamber;
a second fluid passageway between said control chamber and said outlet;
a flow control element in at least one of said passageways;
a biasing means adapted to normally bias said flow control element to a first position, wherein the flow of fluid in at least one of said passageways is impeded and wherein said valve member is urged to said closed position; and,
an activation means, operatively connected to said flow control element, which when activated is adapted to move said flow control element from said first position to a second position, wherein the flow of fluid in said at least one passageway is permitted, causing said valve member to, for a predetermined period of time, move to said open position.

Preferably, said activation means is activated by a user depressing a button against the bias of a spring or other biasing means.

Also preferably, said activation means includes a magnet or electromagnet to cause movement of said flow control element.

Preferably, said biasing means is a spring, the spring being selected according to the desired predetermined period of time for which said valve is desired to be opened.

In a further broad form, the present invention provides a cartridge for a valve device, which may be installed or retrofitted into an otherwise conventional valve device, providing;

a fluid inlet;

a fluid outlet;

a valve seat, defining an opening through which fluid is adapted to flow from said inlet to said outlet;

a valve member, movable relative to said valve seat between an open and a closed position;

a biasing means, adapted to normally bias said valve member to said closed position

a control means, to operate said valve device for a predetermined period of time, said control means including:
a control chamber;
a first fluid passageway between said inlet and said control chamber;
a second fluid passageway between said control chamber and said outlet;
a flow control element in at least one of said passageways;
a relief valve member in said second fluid passageways;
a biasing means adapted to normally bias said relief valve member to a first position, wherein the flow of fluid in at least one of said passageways is impeded and wherein said valve member is urged to said closed position; and,
an activation means, operatively connected to said relief valve member, which when activated is adapted to move said relief valve member from said first position to a second position, wherein the flow of fluid in said at least one passageway is permitted, causing said valve member to, for a predetermined period of time, move to said open position;

Incorporating this arrangement in this valve device enables compact design with a relatively small pressure chamber, compared to the flow duration that can be obtained using conventional techniques.

The self-cleaning and filtering properties of the arrangement, along with its feasibility for achieving minute fluid flow rates, has made it possible to reliably reduce the cross-sectional areas through which the control fluid flows. Consequently, the response time of this type of pressure balanced pilot operated valves is more controllable and the power required to activate them is relatively smaller.

The compactness of the design makes it preferable to retrofit in standard water cocks and water taps to form part of said device.

Also the compactness and the low actuation power requirement makes it preferable to design a universal design that can be activated with much less powerful/robust/and miniaturized types of actuating means. The use of such (weak and miniature) activating means, is been made possible by being able to reduce both the relief port cross-section and the Pilot Flow rate. That is, reduction to both the required forces and their corresponding displacement have been made possible.

### BRIEF DESCRIPTION OF THE DRAWINGS

The present invention will become more fully understood from the following detailed description of preferred but non-limiting embodiments, described in connection with the accompanying drawings, wherein;

FIG. 1 illustrates an isometric view of a time flow valve in accordance with the present invention;

FIG. 2 illustrates an exploded elevational view of the various components of the time flow valve;

FIG. 3 illustrates a cross-sectional view of the time flow valve in its ‘closed’ state;

FIG. 4 illustrates the valve as it is activated;

FIG. 5 illustrates the valve in an intermediary activation step;

FIG. 6 illustrates a further cross-sectional view of the valve during its activation cycle;

FIG. 7 illustrates a further cross-sectional view of the valve as its finalizing its activation cycle;

FIG. 8 illustrates a cross-sectional view of the further embodiment of the passageway and the flow control element;

FIG. 9 illustrates a second position of the components shown in FIG. 8;

FIG. 10 illustrates the time flow valve in a universal cartridge form suitable to retrofit into existing or newly designed valve bodies. In this embodiment, unlike the embodiment of FIGS. 2 to 7, the flow control element 104 is an integral part of spring 117. Also, in this embodiment, the relief valve 106 is not an integral part of the flow control element. Its biasing means in this case is the resilient flange 122 which is adapted to keep it in its normally closed state; and

FIG. 11 shows section views of the universal cartridge form of the valve in four different operating states.

### DETAILED DESCRIPTION OF THE PREFERRED EMBODIMENTS

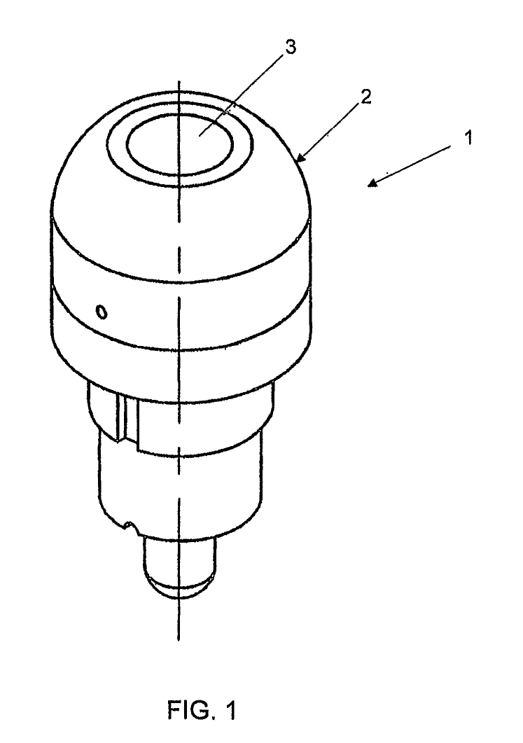

In FIG. 1 is shown an isometric view of a time flow valve, generally designated by the numeral 1 in accordance with the present invention. When installed, the time flow valve 1 of the present invention may have a variety of appearances, but one such appearance of such a time flow valve 1 is illustrated in FIG. 1 which shows a valve 1 having an external cover 2 and an activation button 3. In operation, once installed, a user simply pushes the activation button 3 to initiate an activation cycle and operate the valve. The valve then operates for a period of time and then shuts off automatically. As will be herein after described, the period of time of activation may be adjusted according to various design techniques. The time flow valve of the present invention is useful in a variety of situations, but particularly in the case of public bathrooms or the like wherein it is desired to operate the valve for a period of time, for example 10 seconds, and then automatically shut off the valve such that water is not wasted. The time flow valve shown in FIG. 1 may be installed in a new hydraulic circuit, or, it may be retrofitted into an existing situation.

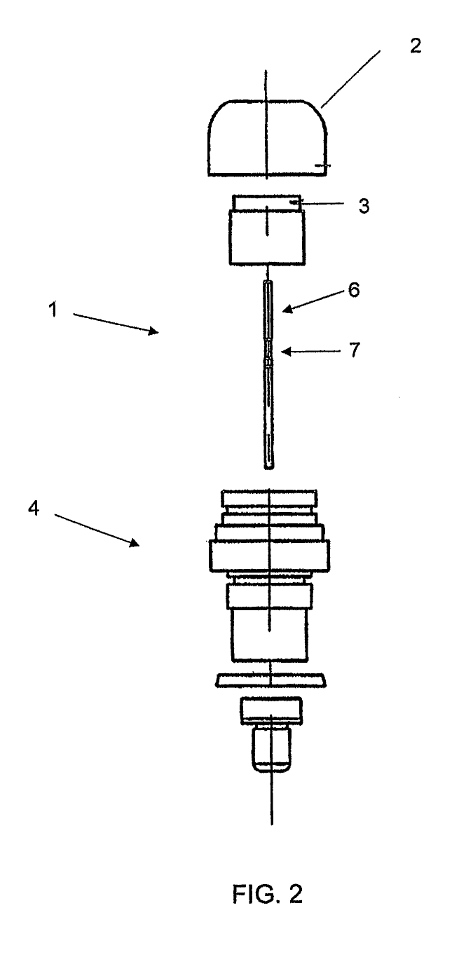

FIG. 2 shows an exploded elevational view of the components of the valve 1, including the activation button 3, the cover 2, the various other valve components 4 which will be hereinafter described, including, importantly, a flow control element 6. It will be particularly noted that the flow control element 6 has a central part thereof 7 which is of narrower cross-section 7 than the remainder of the flow control elements 6, the purpose of which will be described herein after.

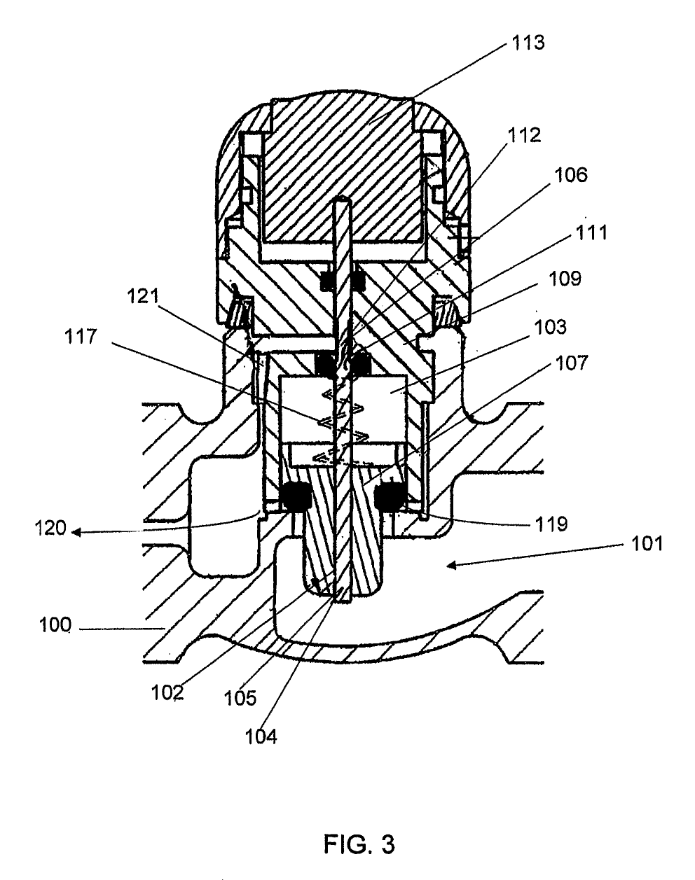

FIG. 3 shows a cross-sectional view of the valve of the present invention in its ‘closed’ state.

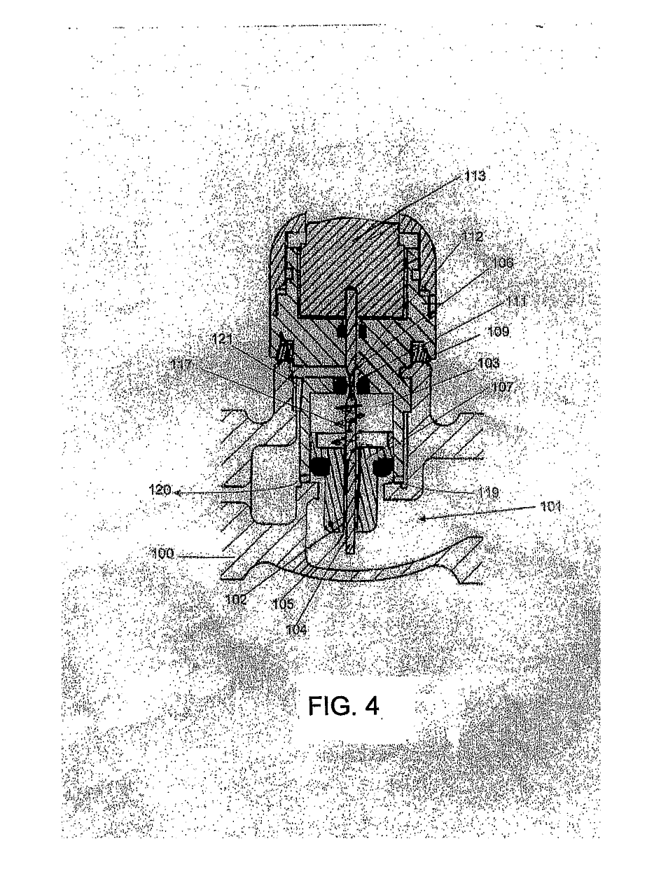

Fluid inlet 101 communicates with the control or pressure chamber 103 via a first passageway 102. The first passageway 102 is formed by a relatively large orifice 105, partially filled with the flow control element 104. The difference in the cross-sectional areas of orifice 105 and element 104 is the actual cross-sectional area of passageway 102. The control chamber 103 is formed between valve member 107 and the valve body 109. The valve member 107 is sealingly movable along the internal walls of the valve body 109 between a closed position (as shown in FIG. 3) and an open position (as shown in FIG. 4) wherein the valve member 107 is away from the valve seat 119.

In a second passageway, downstream of passageway 102 is the relief valve 106 formed by the internal walls of o-ring 111 and the narrower or grooved portion of element 104.

Preferably the narrow end of spring 117 is clipped on element 104. Its large end tends to push valve member 107 towards the valve seat 119 and its narrow end tends to push element 104 so that relief valve 106 remains normally closed. An activation means 113 which is shown as a button, is movable to transmit the activation power to relief valve 106.

Inlet 101 communicates with outlet 120 when valve member 107 moves away from the valve seat 119.

Relief port 121 communicates pressure chamber 103 with outlet 120 via relief valve 106.

FIG. 3 shows the valve in its closed state. That is activation means 113 is in a state that allows spring 117 to keep relief valve 106 closed. The pressure in pressure chamber 103 is now equal to the pressure at inlet 101. The difference between the cross-sectional areas of the sides of valve member 107 subjected to the inlet pressure results in forcing said valve member 107 to seal against valve seat 119 to close the valve.

FIG. 4 illustrates a cross-sectional view of the valve just after the button 113 is depressed, that is, with flow control element 104 activated such that the relief valve 106 opens.

When the energy state of member 113 changes to force the relief valve to open against the bias of spring 117, fluid is then permitted to flow through the relatively unrestricted relief valve 106 and relief port 121.

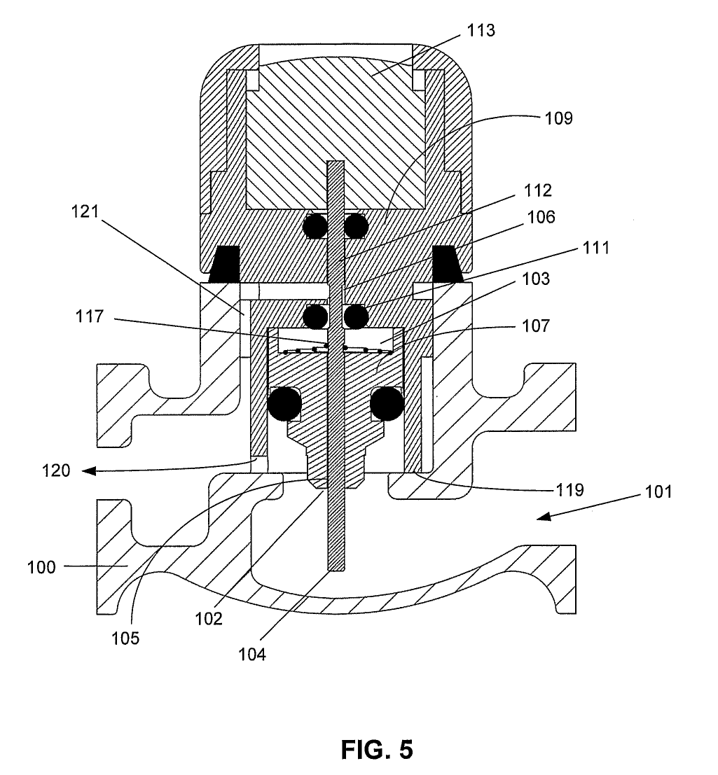

The highly restrictive first passageway 102 reduces the flow of fluid entering pressure chamber 103 to the extent that its pressure drops to levels that allow the valve member 107 to move away from valve seat 119 thereby providing relative movement between element 104 and orifice 105, compressing spring 117 and, allowing the valve to open. FIG. 5 illustrates this position of the valve. That is, the pressure has then dropped in the control chamber 103 such that the valve member 107 is moved away from the valve seat 119, and the flow of fluid from inlet 101 to 120 is then underway.

Said arrangement and the automatic movements of member 104, relative to orifice 105 to form opening 102, provide the self-cleaning and the preferred flow restriction properties of opening 102, and prevent the ingress of particles which otherwise block downstream bypass openings. Particles prevented from entering chamber 103 are washed away with the main flow through the relatively large openings of outlet 120.

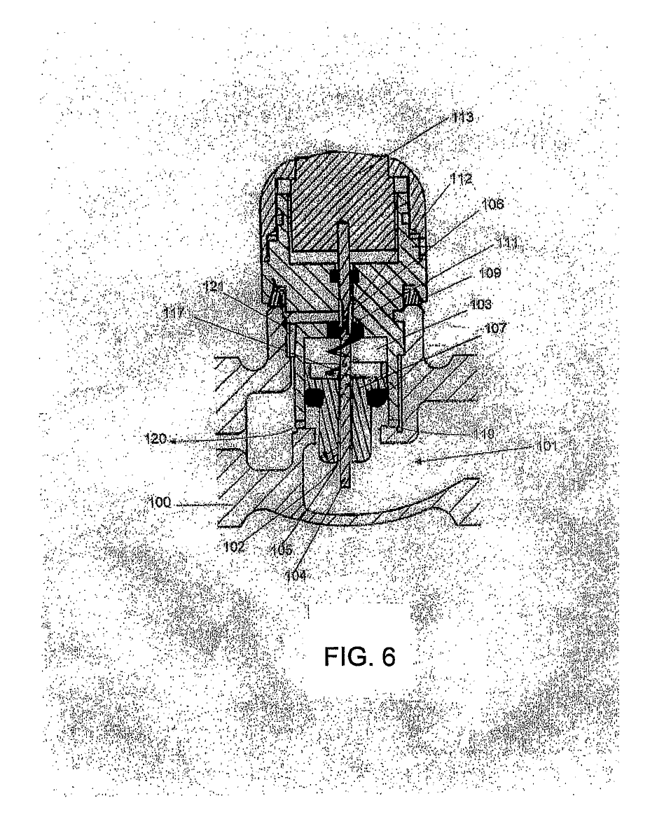

FIG. 6 illustrates a cross-sectional view of the valve when the spring 117 is compressing to close the relief valve 106.

The valve will remain open until the relief valve 106 is caused/allowed to close as described earlier. Once valve 106 is closed, the pressure in control chamber 103 rises to start moving valve member 107 towards valve seat 119 until the valve shuts. The speed at which the valve member 107 moves, towards valve seat 119, varies directly (but not necessarily proportional) with the flow rate of fluid entering control chamber 103. That is highly restrictive first passageway 102 provides slow movement of valve member 107 towards valve seat 119 thereby providing the desired duration of fluid flow.

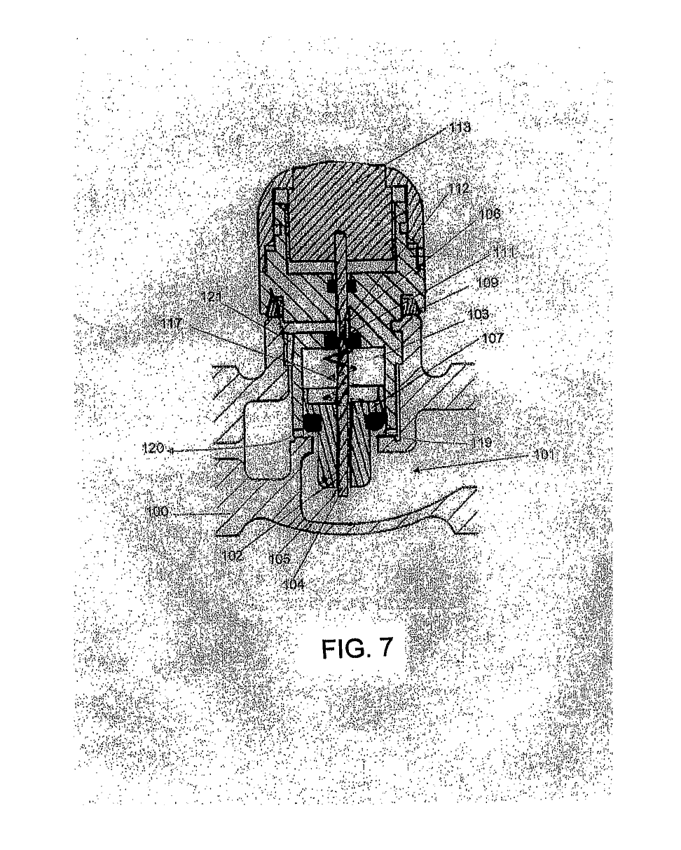

FIG. 7 illustrates a cross-sectional view of the valve with the relief valve 106 closed, such that the pressure in the control chamber 103 is rising to close movable valve member 107 against valve seat 119.

Referring to any one of the FIGS. 3 to 7, operation of the valve 1 may therefore be summarized in the following steps:
1. Push button 113.
2. Button 113 therefore pushes against member 104.
3. Movement of member 104 is against pressure of spring 117.
4. As member 104 moves, relief valve 106 opens, allowing fluid to flow from chamber 103 to outlet 120 via relief port 121.
5. As fluid is expelled from chamber 103 via relief port 121, some fluid enters chamber 103 from inlet 101 via orifice 105.
6. As orifice 105 is very restrictive, and the amount of fluid entering chamber 103 is less than that expelled via relief port, the pressure in chamber 103 drops.
7. As the pressure in chamber 103 drops, valve member 107 moves away from valve seat 119 to open valve, such that fluid flows from inlet 101 to outlet 120.
8. As valve member 107 moves away from valve seat 119, spring 117 is also compressed.
9. As spring 117 is compressed, the relief valve 106 then closes.
10. When relief valve 106 is closed, the pressure in chamber 103 starts to rise and member 107 is moved towards valve seat 119 until the valve again shuts.

The movement of the flow control element 104 relative to orifice 105 whenever the valve is activated can also provide the means for controlling the speed of the shutting and opening speeds (acceleration). One preferred way of achieving this, is by dimensioning the effective flow-path-length of the first passageway 102 to be varied with said relative movement (as shown by FIG. 1), and/or by introducing variation (eg. tapers) on either or both cross-sections of the flow control element 104 and orifice 105.

The cross-sectional area of the internal walls of o-ring 111 is dimensioned so that it is small enough to be closed/opened by small forces, and yet, large enough not to get clogged by solid particles that are small enough to pass through opening 102.

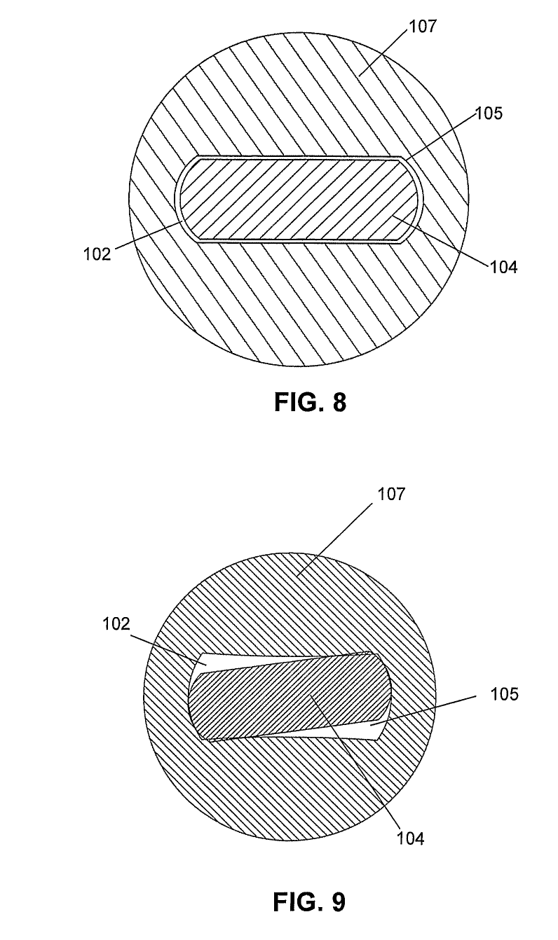

FIGS. 8 and 9 show section views of another preferred arrangement for the passageway 102, in this case it is a non-circular arrangement. Such non-circular arrangements for passageway 102 provide yet another desirable feature to the valve. That is having the choice to shut the valve anytime before it shuts automatically. This is achieved by having flow control element 104 rotatable relative to the resilient walls of orifice 105. This is illustrated by FIG. 9. When the valve opens and the relief valve 106 closes, the non-circular member 104 may be forced to rotate relative to the non-circular orifice 105 to increase the effective cross-section of opening 102 as shown by FIG. 9. This increase in the cross-section will allow the rate of flow of fluid into chamber 103 to increase, thereby increasing the speed at which member 107 normally moves towards valve seat 119. When member 104 is allowed to return or turned to its original state (in this case, by the resilient walls of orifice 105), the valve reverts to its normal state ready for another trigger.

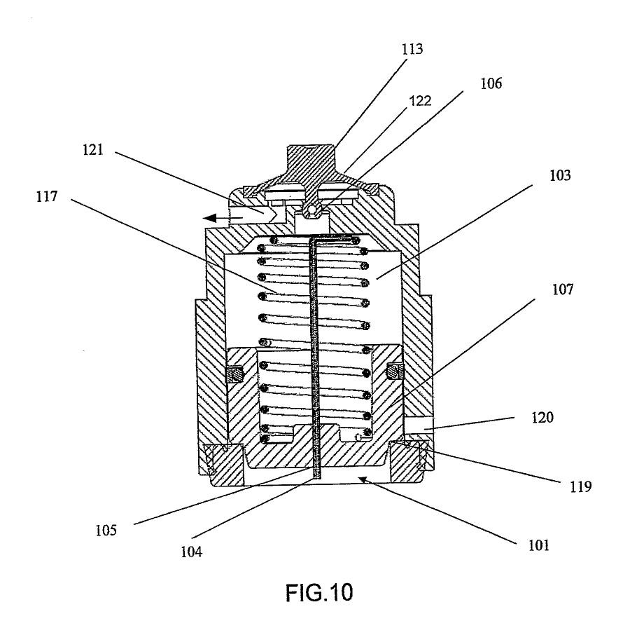

FIG. 10 shows in sectional view, the valve in an universal cartridge form suitable to retrofit into existing or new valve bodies and capable of being actuated with any kind of actuating means as long as said means are capable of delivering the relatively very low forces and the very small corresponding displacement required to control the position of the relief valve member between open and closed positions. That is, unlike conventional means, said actuating means may include much less powerful and miniaturized means and thus making the device suitable for wider range of applications.

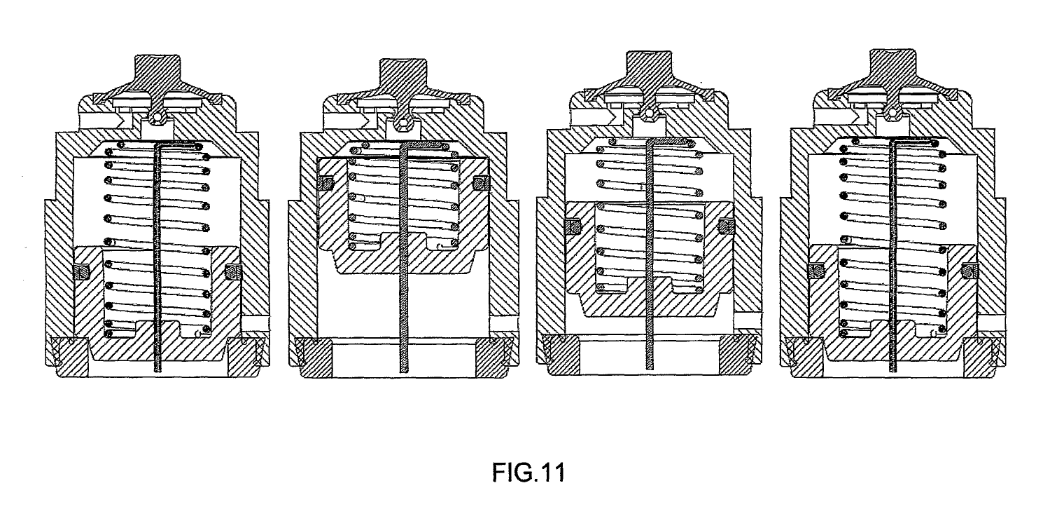

FIG. 11 shows, also in sectional views, various different activation states of the cartridge. It will be appreciated by persons skilled in the art that this ‘cartridge’ may be easily installed into an otherwise conventional valve, to enable the valve to be effectively updated to a valve which only requires relatively low-powered activation, and results in relatively lower flows to operate.

Referring to FIGS. 10 and 11, the operation may be summerised in the following steps;
1. Push button 113.
2. Button 113 therefore pushes against relief valve member 106.
3. Movement of relief valve member 106 is against the biasing means 122.
4. As relief valve member 106 moves, it allows fluid to exit from chamber 103 via relief port 121.
5. As fluid is expelled from chamber 103 via relief port 121, some fluid enters chamber 103 from inlet 101 via orifice 105.
6. As orifice 105 is very restrictive, and the amount of fluid entering chamber 103 is less than that expelled via relief port, the pressure in chamber 103 drops.
7. As the pressure in chamber 103 drops, valve member 107 moves away from valve seat 119 to open valve, such that fluid flows from inlet 101 to outlet 120.
8. As valve member 107 moves away from valve seat 119, spring 117 is also compressed.
9. As spring 117 is compressed, the flow control element 104 (which is an integral part of the fixed end of spring 117) moves relative to valve member 107.
10. When push button 113 is released to allow relief valve 106 to close, the pressure in chamber 103 starts to rise and valve member 107 is moved towards valve seat 119 until the valve again shuts.

It will be appreciated that the time flow valve of the present invention therefore provides a valve which, may be activated by an activation means to open the valve for a period of time. By the design of the valve of the present invention, the valve will automatically shut off at a predetermined period of time. The predetermined period of time may be varied according to the design characteristics of the components of the valve.

It will be appreciated that numerous variations and modifications to this invention will become apparent to persons skilled in the art. All such variations and modifications should be considered to fall within the scope of the invention as broadly hereinbefore described and as hereinafter claimed.

1. A valve device, including:
a fluid inlet;
a fluid outlet;
a valve seat, defining an opening through which fluid is adapted to flow from said inlet to said outlet;
a valve member, movable relative to said valve seat between an open and a closed position;
a control means, to operate said valve device for a predetermined period of time, said control means including:
a control chamber;
a first fluid passageway between said inlet and said control chamber;
a second fluid passageway between said control chamber and said outlet;
a flow control element in at least one of said passageways;
a biasing means adapted to normally bias said flow control element to a first position, wherein the flow of fluid in at least one of said passageways is impeded and wherein said valve member is urged to said closed position; and,
an activation means, operatively connected to said flow control element, which when activated is adapted to move said flow control element from said first position to a second position, wherein the flow of fluid in said at least one passageway is permitted, causing said valve member to, for a predetermined period of time, move to said open position.

2. A valve device as claimed in claim 1, wherein said activation means is activated by a user depressing a button against the bias of a spring or other biasing means.

3. A valve device as claimed in claim 1, wherein said activation means includes a magnet or electromagnet to cause movement of said flow control element.

4. A valve device as claimed in claim 1, wherein said biasing means is a spring, the spring being selected according to the desired predetermined period of time for which said valve is desired to be opened.

5. A valve as claimed in claim 1, wherein said flow control element is substantially elongate, and includes a narrower portion.

6. A valve as claimed in claim 5, wherein said narrower portion of said flow control element is adapted to cooperate with the respective passageway in which it is in.

7. A valve as claimed in claim 6, wherein, upon activation of said activation means, said flow control element moves within said passageway such that flow of fluid is permitted about said narrower portion thereof.

8. A valve as claimed in claim 1, wherein, as said flow control element moves within at least one of said passageways, said flow control element acts to clean or clear said passageway(s) of any particulate matter.

9. A valve as claimed in claim 1, wherein said predetermined amount of time may be varied by one or more of:
varying the length or cross-section of the passageways;
varying the length or cross-section of the flow control element;
varying the length or cross-section of the narrower portion of the flow control element;
varying the size of the flow control chamber;
varying the relative size of the flow control element in the passageway(s);
providing tapers or other variations on the flow control element and/or the passageway(s); or,
varying the cross-section of the passageway(s) and/or the flow control element.

10. A flow control element for a valve device which is adapted to operate for a predetermined period of time, said flow control element including a narrower portion thereof which controls the flow of fluid in a passageway therearound.

11. A flow control element as claimed in claim 10, wherein said flow control element acts to clean or clear any particulate matter from within a passageway in which it is installed.

12. A cartridge for a valve device, which may be installed or retrofitted into an otherwise conventional valve device.

13. A method of operating a valve device, wherein the valve device includes:
a fluid inlet;
a fluid outlet;
a valve seat, defining an opening through which fluid is adapted to flow from said inlet to said outlet;
a valve member, movable relative to said valve seat between an open and a closed position;
a biasing means adapted to normally bias said valve member to said closed position;
a control means, to operate said valve device for a predetermined period of time, said control means including:
a control chamber;
a first fluid passageway between said inlet and said control chamber;
a second fluid passageway between said control chamber and said outlet;
a flow control element in at least one of said passageways;
a relief valve member in said second fluid passageway;
a biasing means adapted to normally bias said relief valve member to a first position, wherein the flow of fluid in at least one of said passageways is impeded and wherein said valve member is urged to said closed position; and,
an activation means, operatively connected to said flow control element, which when activated is adapted to move said relief valve member from said first position to a second position, wherein the flow of fluid in said at least one passageway is permitted, causing said valve member to, for a predetermined period of time, move to said open position;
said method includes the steps of:
operating said activation means, whereby said activation means acts against the bias of said biasing means to move said relief valve member from said first position to said second position, whereby the flow of fluid in said at least one passageway is permitted to cause said valve member to move to said open position for a predetermined period of time.

14. A valve device, substantially as herein described with reference to the accompanying drawings.

15. A flow control element, substantially as herein described with reference to the accompanying drawings.

16. A cartridge for a valve device, substantially as herein described with reference to the accompanying drawings.

17. A method of operating a valve device, substantially as herein described.
